(19) United States
(12) Patent Application Publication
(10) Pub. No.: US 2005/0224368 A1
(43) Pub. Date: Oct. 13, 2005

(54) Polishing system and polishing method

(76) Inventors: Shuzo Sato, Tokyo (JP); Takeshi Nogami, Kanagawa (JP); Shingo Takahashi, Kanagawa (JP); Naoki Komai, Kanagawa (JP); Kaori Tai, Kanagawa (JP); Hiroshi Horikoshi, Kanagawa (JP); Hiizu Ohtorii, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/512,185

(22) PCT Filed: Apr. 14, 2003
(86) PCT No.: PCT/JP03/04695

§ 371 Date: May 13, 2005

(30) Foreign Application Priority Data
Apr. 23, 2002 (JP) 2002-121230

(51) Int. Cl. B23H 5/02

(52) U.S. Cl. 205/660

(57) ABSTRACT

A polishing apparatus and a polishing method by which it is possible to restrain variations in the composition of an electrolytic solution 2 between a wafer 3 and a counter electrode 5, and the like, and to make current density distribution substantially constant in the plane of the wafer. The polishing apparatus, for planarizing a surface to be polished 3a by electrolytic combined polishing composed of a combination of electropolishing and mechanical polishing, includes a voltage impressing means 5 disposed oppositely to the surface to be polished 3a, and a discharging means for discharging foreign matter intermediately present between the voltage impressing means 5 and the object of polishing.

### TECHNICAL FIELD

The present invention relates to a polishing apparatus and a polishing method. More particularly, the present invention relates to a polishing apparatus and a polishing method which are suitable for manufacture of a semiconductor device.

### BACKGROUND ART

In recent years, electronic apparatuses such as TV sets, personal computers and cellular phones have become required to be smaller in size, higher in performance and of multiple functions, and LSIs which are semiconductor devices mounted on these electronic apparatuses have become demanded to be more higher in operating speed and to consume further less electric power. To meet these demands, miniaturization of semiconductor devices and multiple-layer structures therefor have progressed, and optimization of the materials for forming the semiconductor devices has also been conducted. At present, there is a request for a wiring forming technology capable of coping with the 0.1 μm generation, so called in the design rule for semiconductor devices, and the latter generations.

Besides, in the manufacturing processes of semiconductor apparatuses, it has being coming to be difficult with formation of wirings by photolithography to form wirings with sufficient accuracy, attendant on the miniaturization of wirings formed in semiconductor devices. In view of this problem, there is widely practiced a method of forming wirings by preliminarily providing an inter-layer insulation film with trench-formed wiring patterns, filling up the wiring patterns with a metal, and removing the surplus metal by a chemical mechanical polishing method (hereinafter referred to as CMP method).

Meanwhile, attendant on the miniaturization of wirings, the ratio in which wiring delay contributes to operation delay of semiconductor devices has become non-ignorable. In order to reduce the wiring delay, copper having a lower resistivity has been adopted as a substitute for aluminum, which has conventionally been widely used as the material for forming the wirings, from about the 0.1 μm generation on. Furthermore, in the 0.07 μm generation, the proportion of the operation delay arising from a combination of a silicon oxide based insulation film and copper wirings based on the operation delay of the device transistor itself is increased, it has become important to reduce the CR delay of wirings by further reducing the dielectric constant of the conventional wiring structure, particularly the dielectric constant of the insulation film.

In view of the foregoing, in order to meet the demand for further higher operating speed and less power consumption of LSIs, a method of reducing the CR delay of wirings by not only forming the wirings from copper but also forming the insulation film by use of an ultra-low dielectric constant material, for example, porous silica having a dielectric constant of 2 or below, has been investigated.

However, in polishing a copper thin film formed of the ultra-low dielectric constant material by the conventional CMP method, the processing pressure exerted is in the range of about 4 to 6 Psi (1 Psi is equivalent to about 70 g/cm²), and, under the processing pressure, the ultra-low dielectric constant material would undergo damages such as collapse, cracks and exfoliation, making it impossible to achieve favorable wiring formation. In view of this, a reduction of the processing pressure to about 1.5 Psi or below, which is the pressure the ultra-low dielectric constant material can endure mechanically, has been investigated, but this approach involves the problem that it is impossible to attain the polishing rate necessary for securing a satisfactory production speed.

In addition, when plating for filling up trenches, via holes and the like is applied to an insulation film provided with the trenches, via holes and the like by the Damascene process or dual Damascene process, an electroplating solution with various additives added thereto may be used for achieving perfect filling-up without generation of such defects as voids and pits. In such a case, the surface of the metallic film formed by the plating would have, left therein, an unevenness composed of such patterns as raised portions (humps) in size of not less than a predetermined value in minute wiring concentration areas and recesses in broad wiring areas. Where a dissolution treatment such as electropolishing by reverse electrolysis of the plating is conducted for planarizing the unevenness without exerting an excessive processing pressure on the insulation film by the CMP method, it is impossible to planarize the unevenness because the material is dissolved from the surface layer conformally and uniformly. As a result, over-polishing such as local losing of wirings, dishing (hollowing) and recess (shrinkage) or under-polishing such as shortcircuits (contact due to left Cu between adjacent wirings) and islands (remaining of Cu in island-like form) occurs upon the end of polishing, and it is therefore difficult to obtain a sufficient planarness, though it is possible to prevent the occurrence of breakage under a mechanical pressure.

In view of the above, a technology in which the surface of a metallic film for constituting wirings is planarized by a polishing method composed of a combination of both the CMP technique and the electropolishing technique has been investigated. For example, according to the technology disclosed in Japanese Patent Laid-open Nos. 2001-077117 and 2001-326204, for conducting electropolishing, an electric current is passed to a copper film on the surface of a wafer which is the object to be processed, with the copper film as anode, and an electrolytic current is passed by impressing an electrolytic voltage between the copper film and a cathode disposed oppositely to the wafer through an electrolytic solution. The surface of the copper film receiving an electrolytic action as anode is anodically oxidized, whereby a copper oxide coating is formed at the surface layer, and the oxide and a copper complex forming agent contained in the electrolytic solution react with each other, whereby a denatured layer such as a high electric resistance layer, an insoluble complex coating and a passivation coating is formed from the complex forming agent substance. The denatured layer at the surface of the copper film is wiped by sliding a pad thereon simultaneously with the electrolysis, whereby the denatured layer coating at the surface layer of projected portions is removed, to expose the underlying copper, and the cycle including the local re-electrolysis is repeated, whereby the surface of the copper film can be planarized.

However, the technology disclosed in the laid-out publications mentioned above has the following problem. When it is assumed that an electrolytic medium based on a slurry containing abrasive slurry for use in CMP and rendered electrically conductive is used as an electropolishing liquid for enhancing the planarizing ability, a slurry based on alumina abrasive grains, upon coagulation of the abrasive grains, would easily cause fatal defects such as scratches and also cause dispersion of current density distribution. Therefore, there is adopted a technique of holding alumina abrasive grains in an acid and holding them in the state of being electrolyzed in plus (+) polarity so that the abrasive grains repel each other and are thereby prevented from coagulating. However, in a neutral to alkaline region, the zeta potential of the abrasive grains is lowered, with the result of coagulation or precipitation of the abrasive grains. Thus, this technique has not yet reach such a satisfactory level as to sufficiently suppress the generation of huge scratches and the remaining of gigantic abrasive grains, upon polishing.

Besides, the products from the electrolytic liquid, slob and sludge, after the electrolytic action during the electropolishing, would vary the composition, pH, component concentrations, etc. of the electrolytic liquid, to thereby make electrolytic characteristics instable. Here, principal components of the electrolytic liquid include the following ones, and the conductivity, pH and component concentrations are varied every moment by the electrolytic products.

(1) Electrolytes: Dissociated ions and the like for enhancing the conductivity of the liquid.

(2) Oxidizing agent: Accelerates the oxidation of the Cu surface layer so as to assist the anodic oxidation (e.g., H₂O₂).

(3) Complex forming agent: Reacts with the copper oxide to form an insoluble complex (e.g., quinaldic acid).

(4) Abrasive gains: Enhances the mechanical material removal efficiency and the planarizing efficiency (e.g., alumina).

(5) Surfactant: Prevention of coagulation or precipitation of the abrasive grains.

(6) Other additives: Stabilizer, buffer, etc.

Furthermore, in the case where the wafer is disposed face up and a polishing pad and a counter electrode (cathode) are disposed oppositely to the wafer, bubbles of the gas evolved by the electrolytic action would be accumulated on the surface of the counter electrode, so that the electrode surface portion cannot make contact with the electrolytic liquid and is hence insulated, with the result of considerable variations in the electrolytic conditions, such as variations in current density, insulation, etc.

The present invention has been made in consideration of the above-mentioned problems. Accordingly, it is an object of the present invention to provide a polishing apparatus and a polishing method by which it is possible to restrain variations in the composition of an electrolytic solution between a wafer and a counter electrode and the like, to discharge the products formed upon electropolishing, coagulated matter generated upon mechanical polishing and the like, and to render current density distribution nearly constant in the wafer plane.

### DISCLOSURE OF INVENTION

According to the present invention, there is provided a polishing apparatus for planarizing a surface to be polished by electrolytic combined polishing composed of a combination of electropolishing and mechanical polishing, the apparatus including: voltage impressing means disposed oppositely to the surface to be polished; and discharging means for discharging foreign matter intermediately present between the voltage impressing means and the surface to be polished.

With the electrolytic solution caused to flow along the radial direction of the surface to be polished, it is possible to reduce the dispersion of the components of the electrolytic solution contributing to the electrolytic action in the surface to be polished and the like. In addition, by discharging the foreign matter such as the products formed upon the electrolytic action, it is possible to reduce the dispersion of current density distribution between the surface to be polished and the voltage impressing means. Therefore, it is possible to uniformly planarize the surface to be polished.

Besides, according to the present invention, there is provided a polishing method for planarizing a surface to be polished by electrolytic combined polishing composed of a combination of electropolishing and mechanical polishing, wherein a counter electrode is disposed oppositely to the surface to be polished, and foreign matter intermediately present between the counter electrode and the surface to be polished is discharged, whereby current density distribution is made nearly uniform between the counter electrode and the surface to be polished. Accordingly, by making the current density distribution between the counter electrode and the surface to be polished nearly uniform in the surface to be polished, it is possible to planarize the whole part of the surface to be polished.

### BRIEF DESCRIPTION OF DRAWINGS

FIG. 1 is a sectional structural view showing one example of a polishing apparatus in a first embodiment of the present invention.

FIG. 2 is a sectional structural view showing one example of the polishing apparatus in the first embodiment of the present invention.

FIG. 3 is a sectional structural view showing one example of the polishing apparatus in the first embodiment of the present invention.

FIG. 4 is a sectional structural view showing one example of the polishing apparatus in the first embodiment of the present invention.

FIG. 5 is a sectional structural view showing one example of the polishing apparatus in the first embodiment of the present invention.

FIG. 6 is a sectional structural view showing the structure of a spindle rotating mechanism portion suitable for the polishing apparatus in the first embodiment of the present invention.

FIGS. 7(a) and 7(b) show general structural views of a partial-type polishing apparatus suitable for the polishing apparatus in the first embodiment of the present invention, in which FIG. 7(a) is a plan structural view, and FIG. 7(b) is a sectional structural view.

FIGS. 8(a) and 8(b) show structural views showing the structure of a flange fitted with a pad suitable for the polishing apparatus in the first embodiment of the present invention, in which FIG. 8(a) is a sectional structural view, and FIG. 8(b) is a plan structural view of the pad.

FIG. 9 is a diagram for illustrating one example of current measuring method.

FIGS. 10A and 10B illustrate one example of arrangement pattern of through-holes formed in a pad, in which FIG. 10A is a plan view, and FIG. 10B is a sectional view.

FIG. 11 is a sectional structural view showing one example of the polishing apparatus in the first embodiment of the present invention.

FIG. 12 is a sectional structural view showing one example of a polishing apparatus in a second embodiment of the present invention.

FIG. 13 is a sectional structural view showing one example of the polishing apparatus in the second embodiment of the present invention.

FIG. 14 is a sectional structural view showing one example of the polishing apparatus in the second embodiment of the present invention.

FIG. 15 is a sectional structural view showing one example of the polishing apparatus in the second embodiment of the present invention.

FIGS. 16(a) and 16(b) show plan structural views showing the structure of a partial-type polishing apparatus suitable for the polishing apparatus in the second embodiment of the present invention, in which FIG. 16(a) is an overall view, and FIG. 16(b) is an enlarged view obtained by enlarging FIG. 16(a).

FIGS. 17A and 17B are sectional structural views showing the structure of the partial-type polishing apparatus suitable for the polishing apparatus in the second embodiment of the present invention, in which FIG. 17A is an overall view, and FIG. 17B is an enlarged view obtained by enlarging FIG. 17A.

FIGS. 18(a) and 18(b) show structural views showing the structure of an orbital-type polishing apparatus suitable for the polishing apparatus in the second embodiment of the present invention, in which FIG. 18(a) is a plan structural view, and FIG. 18(b) is a sectional structural view.

FIGS. 19A and 19B are structural views showing the structure of a linear-type polishing apparatus suitable for the polishing apparatus in the second embodiment of the present invention, in which FIG. 19A is a plan structural view, and FIG. 19B is a sectional structural view.

### BEST MODE FOR CARRYING OUT THE INVENTION

Now, the polishing apparatus and the polishing method according to the present invention will be described below referring to the drawings.

[First Embodiment]

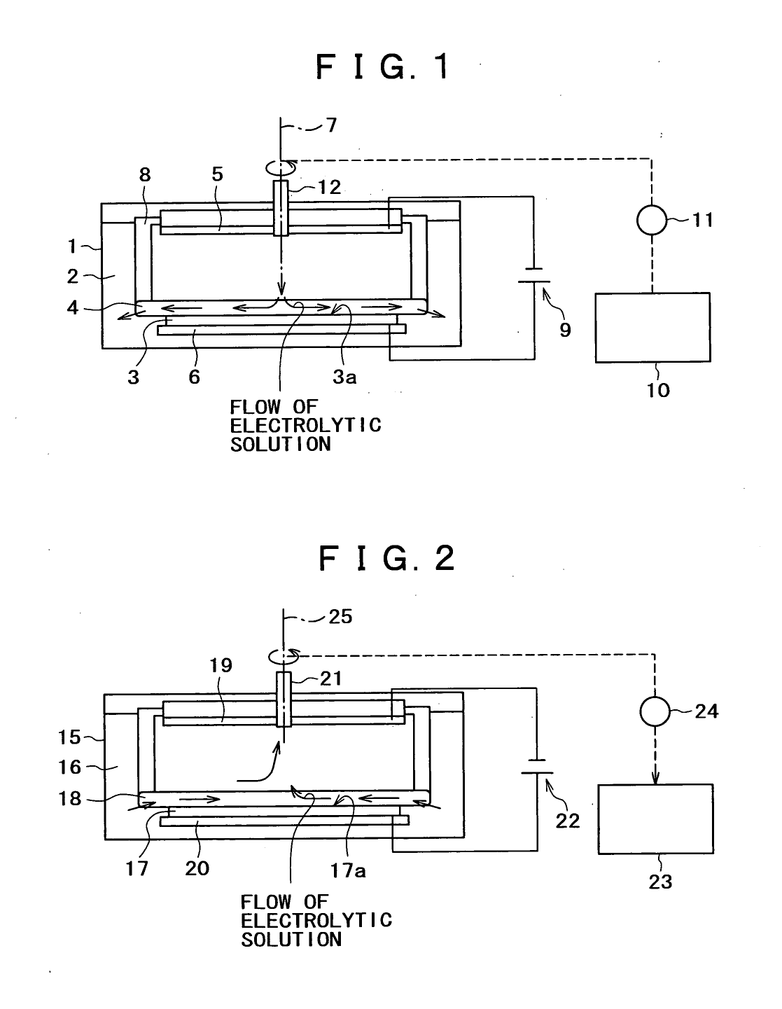

First, the basic configuration of the polishing apparatus according to this embodiment will be described referring to FIGS. 1 to 5. FIGS. 1 to 5 illustrate a wafer face-up type polishing apparatus in which a wafer is disposed with its surface to be polished being directed upwards, and generally illustrate the vicinity of a flange fitted with a pad which is a polishing tool. In addition, in the wafer face-up type polishing apparatus, since the active surface of a counter electrode is directed downwards, collection and stagnation of the gas generated upon electropolishing would cause insulation, an increase in resistance, and dispersion of current density distribution. Accordingly, a polishing apparatus which can suppress these problems will be described in this embodiment.

FIG. 1 is a sectional structural view showing one example of the polishing apparatus according to this embodiment, in which a wafer 3, a pad 4 and a counter electrode 5 are entirely immersed in an electrolytic solution 2 reserved in an electrolytic tank 1. The wafer 3 is composed of an insulating material, and a metallic film formed on the surface of the insulating material, and is fixed on a surface plate 6 so that the surface to be polished, or the surface of the metallic film, is directed to the upper side. The wafer 3 is composed, for example, of an insulation film for insulation between a multiplicity of wiring layers, and a metallic film covering the wafer surface so as to fill up trench portions formed in the insulation film. As the material constituting the insulation film, for example, an insulating material having a comparatively low dielectric constant such as, for example, porous silica having a dielectric constant of 2 or below, can be used. As the material constituting the metallic film, for example, copper can be used, for suppressing wiring delay.

The pad 4 is fixed to a flange 8, with a rotary shaft 7 connected thereto, and is rotated about the rotary shaft 7 in the state of being pressed against the surface to be polished 3a of the wafer 3, to thereby polish the surface to be polished 3a. The flange 8 is provided with a counter electrode 5 disposed oppositely to the wafer 3. The counter electrode 5 and the metallic film formed on the surface to be polished 3a of the wafer 3 are connected to an electrolytic power source 9 disposed in the exterior of the electrolytic tank 1, with the metallic film on the surface to be polished 3a as anode and with the counter electrode 5 as cathode. In addition, at the center of the counter electrode 5, there is disposed a nozzle 12 for supplying the electrolytic tank 1 with an electrolytic solution 2 fed out from an electrolytic solution supply tank 10 disposed in the exterior of the electrolytic tank 1 through a pump 11. The electrolytic solution 2 supplied through the nozzle 12 is supplied to the surface to be polished 3a through the pad 4 in the manner of spreading from the center toward the peripheral edge of the pad 4. As a result, the electrolytic solution 2 with a uniform composition is constantly supplied along the direction from the center toward the peripheral edge of the surface to be polished 3a, whereby dispersion of the composition of the electrolytic solution 2 due to electropolishing is reduced along the radial direction of the surface to be polished 3a, and, in addition, the rotation of the wafer 3 suppresses dispersion of the composition of the electrolytic solution 2 in the circumferential direction of the surface to be polished 3a. Furthermore, the spreading of the electrolytic solution along the directions from the center toward the peripheral edge of the surface to be polished 3a ensures that the gas and solid matter generated by electropolishing, the polishings accumulated between the pad 4 and the surface to be polished 3a due to mechanical polishing, the coagulated matter arising from coagulation of abrasive grains and the like contained in the electrolytic solution, etc. are discharged from the area of the surface to be polished 3a into the inside of the electrolytic tank 1. In this case, the electrolytic solution 2 flows also in the vicinity of the active surface composed of the surface of the counter electrode 5, whereby the products arising from electropolishing can be discharged.

In the next place, FIG. 2 is a sectional structural view of another example of the polishing apparatus according to the present embodiment, in which a wafer 17, a pad 18 and a counter electrode 19 are entirely immersed in an electrolytic solution 16 reserved in an electrolytic tank 15, and the wafer 17 is fixed to a surface plate 20 with its surface to be polished 17a being directed to the upper side, whereby the surface to be polished 17a composed of the surface of a metallic film is mechanically polished with the pad 18 and electropolished, to be planar. In FIG. 2, a nozzle 21 disposed at the center of the counter electrode 19 sucks the electrolytic solution 16 intermediately present between the pad 18 and the surface to be polished 17a, and the electrolytic solution 16 is thereby caused to flow from the peripheral edge toward the center of the surface to be polished 17a and is discharged through a pump 24 into an electrolytic solution tank 23, whereby dispersion of the composition of the electrolytic solution 16 in the radial direction of the surface to be polished 17a is reduced; in addition, due to the rotation of the wafer 17, dispersion of the composition of the electrolytic solution 16 in the circumferential direction of the surface to be polished 17a is also reduced. Furthermore, the electrolytic solution 16 flowing from the peripheral edge toward the center of the surface to be polished 17a is discharged via the nozzle 21, whereby the gas and solid matter generated by electropolishing, the polishings accumulated between the pad 18 and the surface to be polished 17a upon mechanical polishing, the coagulated matter arising from coagulation of abrasive grains and the like contained in the electrolytic solution 16, etc. are discharged into the inside of the electrolytic tank 15. Besides, the counter electrode 19 and the surface to be polished 17a are connected to an electrolytic power source 22, to serve as cathode and anode respectively. Here, the pad 18 is rotated about its center, whereby the surface to be polished 17a is mechanically polished effectively.

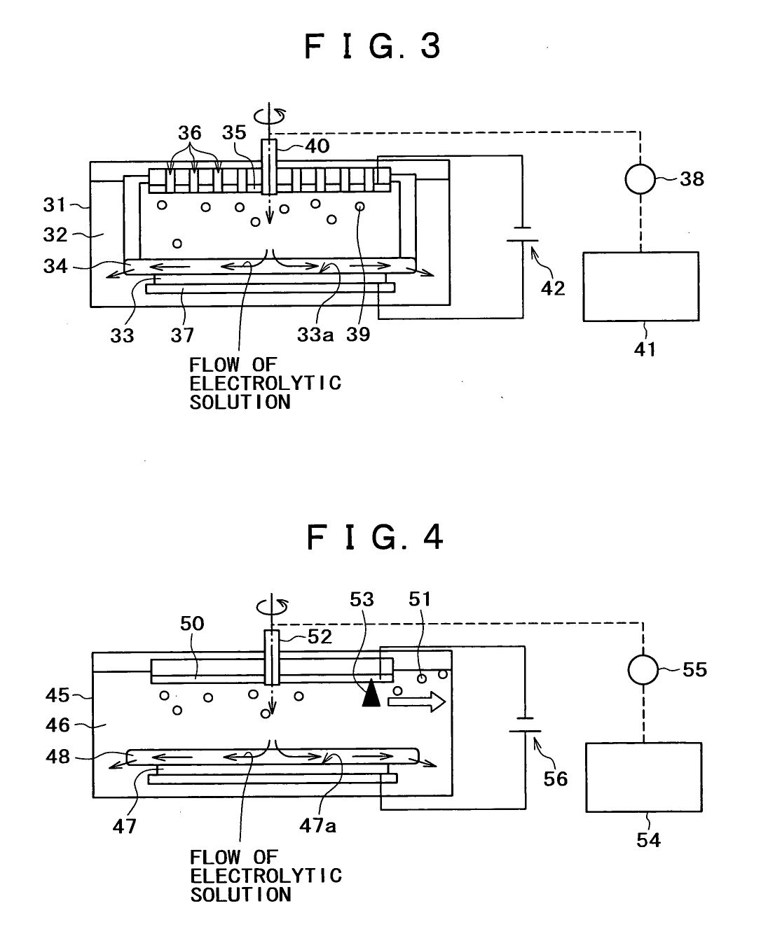

FIG. 3 illustrates one example of the polishing apparatus in which a counter electrode 35 is provided with discharge holes 36. The discharge holes 36 are so provided as to be distributed in a roughly uniform density in the plane of the counter electrode 35, and the total area of the openings of the discharge holes 36 is set at such a level that the polishing rate of electropolishing will be satisfactory on a practical-use basis. The discharge holes 36 are connected to a pump 38 disposed in the exterior, whereby an electrolytic solution 32 is discharged into an electrolytic solution tank 41, and bubbles 39 containing the gas generated upon electropolishing are discharged under suction. In this case, the electrolytic solution 32 is supplied via a nozzle 40 disposed at the center of the counter electrode 35, and is caused to flow through a pad 34 and along the direction from the center toward the peripheral edge of a surface to be polished 33a, whereby solid matter and bubbles 39 generated upon electropolishing can be discharged together with the electrolytic solution 32 intermediately present between the surface to be polished 33a and the pad 34. In addition, while an example in which the electrolytic solution 32 is supplied via the nozzle 40 is shown in FIG. 3, the electrolytic solution 32 may be sucked via the nozzle 40; in the latter case, the electrolytic solution 32 is caused to flow from the peripheral edge toward the center of the surface to be polished 33a, whereby the electrolytic solution 32 can be discharged. Besides, the surface to be polished 33a and the counter electrode 35 are connected to an electrolytic power source 42, to serve as anode and cathode respectively.

FIG. 4 is a sectional structural view of a polishing apparatus so configured that bubbles 51 adhering to the side of a counter electrode, serving as cathode, upon electropolishing can discharged by wiping with a wiper 53. The wiper 53 is slid on the surface of the counter electrode 50 in the direction toward the peripheral edge of the counter electrode 50, whereby the bubbles 51 containing a gas and adhering to the active surface of the counter electrode 50 are removed, and are discharged from an electrolytic solution 46 present between the counter electrode 50 and a wafer 47. Therefore, the bubbles 51 generated upon electropolishing and adhering to the active surface of the counter electrode 50 can be discharged uniformly in the plane of a surface to be polished 47a, so that the phenomenon in which the area between the counter electrode 50 and the wafer 47 might be locally insulated by the bubbles 51 with the result of a non-uniform current density distribution can be restrained. Particularly, where the counter electrode 50 and the pad 48 are not integrally fixed by a flange, there is no obstacle against the sliding of the wiper 53 on the active surface of the counter electrode 50, so that it is possible to mechanically polish the surface to be polished 47a of the wafer 47 and to collectively discharge the gas generated upon electropolishing. Besides, an electrolytic tank 45 is connected to an electrolytic solution tank 54 via a pump 55, and the electrolytic solution 46 is supplied into the electrolytic tank 45 through a nozzle 52. In addition, the surface to be polished 47a and the counter electrode 50 are connected to an electrolytic power source 56, to serve as anode and cathode respectively.

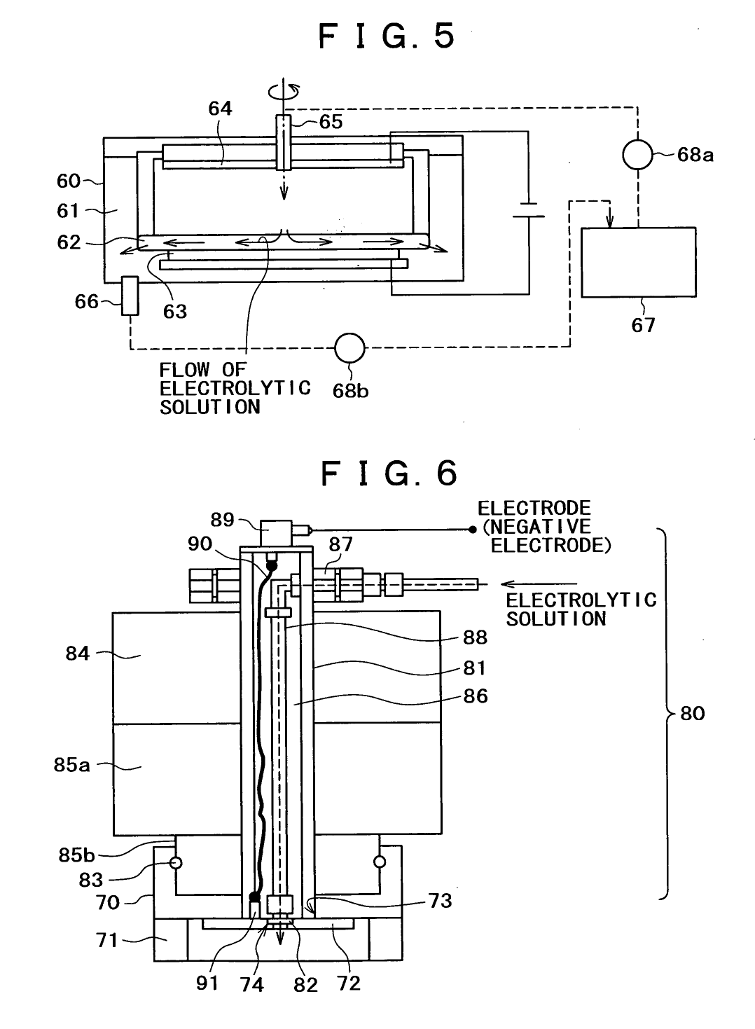

FIG. 5 is a sectional structural view of a polishing apparatus so configured that an electrolytic solution tank 67 for circulating an electrolytic solution 61 between itself and an electrolytic tank 60 in which a counter electrode 64, a pad 62 and a wafer 63 are immersed in the electrolytic solution 61 is connected to the electrolytic tank 60. A nozzle 65 for supplying the electrolytic solution 61 therethrough is disposed at the center of the counter electrode 64, and the electrolytic tank 60 is provided with a drain 66 for feeding out the electrolytic solution 61 contained in the electrolytic tank 60 into the electrolytic solution tank 67. Pumps 68a and 68b are connected respectively to the electrolytic solution supply side and the electrolytic solution suction side of the electrolytic solution tank 67, for supplying the electrolytic solution 61 from the electrolytic solution tank 67 to the nozzle 65 and for sucking the electrolytic solution 61 via the drain 66, whereby the electrolytic solution 61 is circulated between the electrolytic tank 60 and the electrolytic solution tank 67. As a result, the electrolytic solution 61 contained in the electrolytic tank 60 is constantly replaced by the electrolytic solution stored in the electrolytic solution tank 67, so that the electrolytic solution with a reduced dispersion of composition can be used for polishing, instead of continuedly using the electrolytic solution denatured through electropolishing. Particularly, where the capacity of the electrolytic solution tank 67 is set greater than the capacity of the electrolytic tank 60, the electrolytic solution can be replaced efficiently. For example, where the capacity of the electrolytic tank 60 is 5 L, it suffices to set the capacity of the electrolytic solution tank 67 at about 20 L.

Next, the face-up type polishing apparatus in the present embodiment will be described more in detail. Incidentally, while examples of a polishing mechanism preferable for use in the face-up type polishing apparatus in this embodiment include those of the partial type and those of the orbital type, the following description of this example will be based on the partial type polishing mechanism.

FIG. 6 is a sectional structural view showing one example of a spindle mechanism in an electropolishing apparatus preferable for use in the face-up type polishing apparatus. As shown in FIG. 6, a ring pad 71 and a counter electrode 72 are attached to a wheel flange 70. The wheel flange 70 is provided with an insertion port 73 for inserting therein a shaft 81 constituting a spindle rotating mechanism portion 80, and the wheel flange 70 with the shaft 81 inserted in the insertion port 73 is clamped by a flange clamp portion 83. Furthermore, the bottom surface of the insertion port 73 is provided with an insertion port 74 for inserting therein a nozzle 82 protruding from the tip end of the shaft 81, and the insertion port 74 is formed to penetrate through the center of the counter electrode 72, whereby the electrolytic solution is supplied to the active surface, on the side for fronting on the wafer, of the counter electrode 72, and polishing is conducted by the ring pad 71.

The spindle rotating mechanism portion 80 is composed of a built-in motor 84 for rotating the shaft 81, and air bearings 85a, 85b for enabling smooth rotation of the shaft 81. The shaft 81 is provided with a hollow portion 86 formed along the longitudinal direction thereof, and an electrolytic solution is supplied into the hollow portion 86 through an electrolytic solution supply pipe 88 connected to an externally disposed electrolytic solution supply source through a rotary joint 87, and is then supplied to the active surface of the counter electrode 72 through a nozzle 82. In addition, a rotary joint 89 connected to an external power source is disposed at the top end of the shaft 81, and a wiring 90 led out from the rotary joint 89 into the hollow portion 86 is connected to a probe 91 disposed at the bottom end of the shaft 81. The probe 91 is brought into contact with the counter electrode 72 when the shaft 81 is inserted in the insertion port 73, whereby the counter electrode 72 is connected to the power source. Besides, in order that the ring pad 71 worn through polishing can be replaced, the wheel flange 70 can be attached to and detached from the spindle rotating mechanism portion 80, and the ring pad 71 can be replaced as one body with the wheel flange 70.

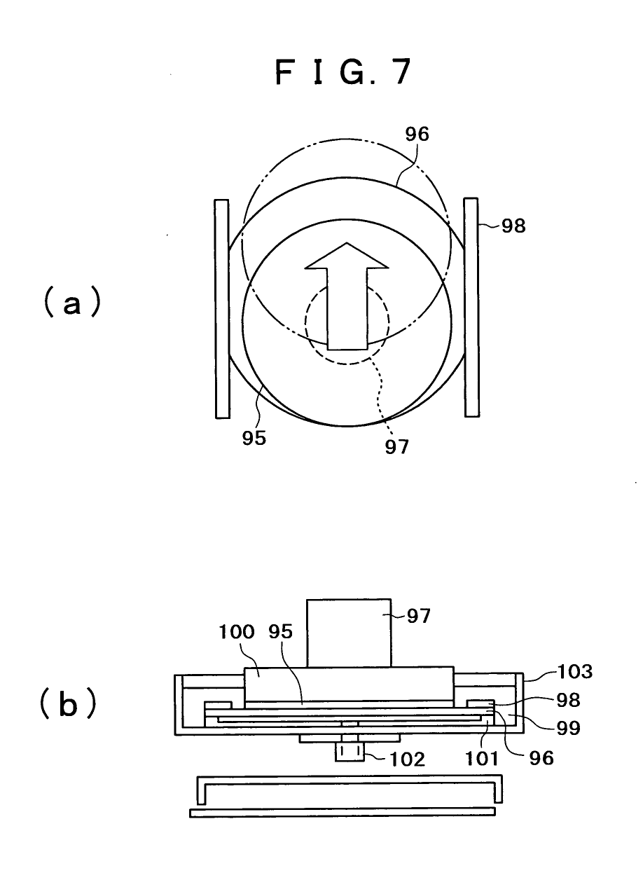

FIGS. 7(a) and 7(b) show general structural views of the vicinity of a flange disposed in the partial type polishing apparatus, in which FIG. 7(a) is a plan structural view, and FIG. 7(b) is a sectional structural view. As shown in FIG. 7(a), the shape of a pad 95 is a roughly circular shape somewhat smaller than a roughly circular wafer 96. The pad 95 is slid along the surface of the wafer 96 while being rotated about a pad rotating shaft 97 disposed at the center thereof, whereby nearly the whole area of a surface to be polished can be polished.

In addition, as shown in FIG. 7(b), the partial type polishing apparatus includes an electrolytic solution 99 contained in an electrolytic tank 103, the pad 95 fixed to a flange 100, and a wafer chuck 101 to which the wafer 96 is to be fixed, and polishing is conducted by pressing the pad 95 against the upper surface, serving as the surface to be polished, of the wafer 96. The pad rotating shaft 97 serving as a rotary shaft is connected to the center of the flange 100, and, when the pad rotating shaft 97 is rotated, the pad 95 is rotated about its center so as to mechanically polish the surface to be polished. Furthermore, a rotary shaft 102 is connected to the center of the wafer chuck 101, and the wafer 96 itself is rotated about its center in the direction opposite to the rotating direction of the pad 95, whereby efficient polishing is achieved. In addition, a metallic film formed on the surface to be polished of the wafer 96 and a counter electrode disposed at the pad 95 are connected to a power source so that the metallic film serves as anode while the counter electrode serves as cathode, and electropolishing is performed.

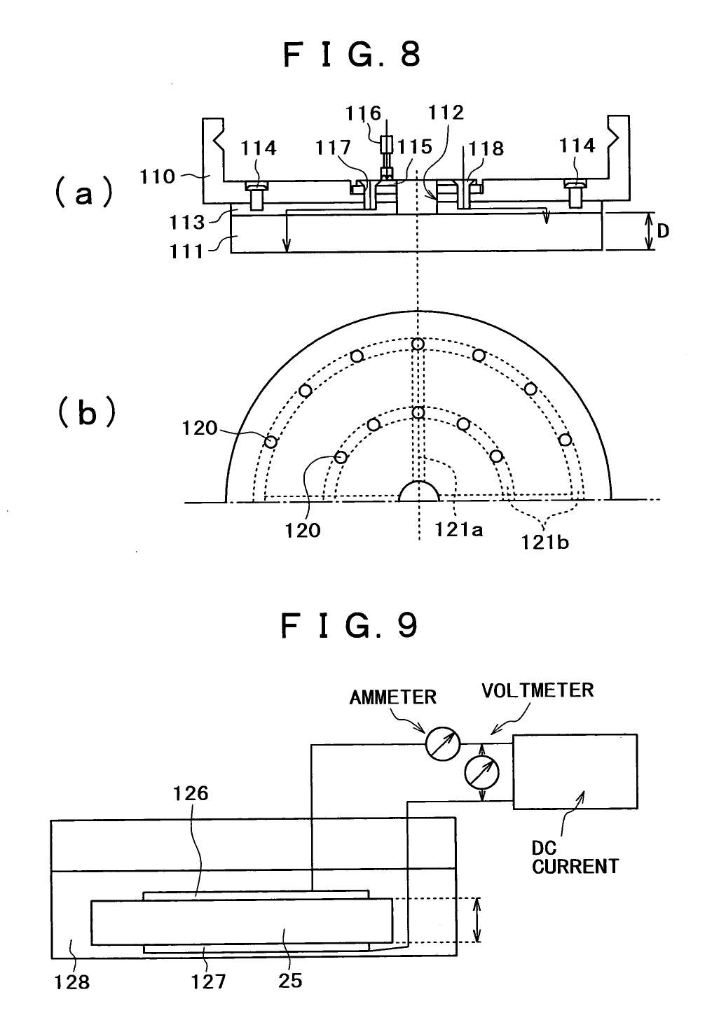

In the next place, the structures of the flange 110 and the pad 111 attached to the flange 110 so as to function as a polishing tool will be described. FIG. 8(a) is a sectional structural view of the flange 110 to which the pad 111 is attached, and FIG. 8(b) is a plan structural view of the pad 111. Incidentally, FIG. 8(b) shows only one half of the pad 111. As shown in FIG. 8(a), the flange 110 is provided in its center with a flange through-hole 112 for supplying or sucking an electrolytic solution, and a counter electrode 113 mounted between the pad 111 and the flange 110 is fixed to the flange 110 by electrode fixing screws 114. A conduction portion 115 is formed along the circumferential direction of the flange through-hole 112, and a connector 116 connected to an external power source is in contact with the conduction portion 115. In addition, the conduction portion 115 is provided with a hole 117 communicated with the flange 110 and reaching the counter electrode 113, a conductive screw 118 is inserted in the hole 117 so as to electrically connect the conduction portion 115 and the counter electrode 113 to each other, thereby establishing an electrical connection ranging from the connector 116 to the counter electrode 113. In addition, the pad 111 has a thickness D, and is so attached as to cover nearly the whole surface of the counter electrode 113. As a result, the surface on one side of the pad 111 makes contact with the counter electrode 113 over nearly the entire area, the surface on the other side makes contact with the wafer, and the inter-electrode distance between the counter electrode 113 and the surface to be polished of the wafer is nearly equal to the thickness D of the pad 111.

Examples of the material constituting the pad 111 include foamed products of foamed polyurethane (PU), polypropylene (PP), polyvinyl acetal (PVA), or other comparatively soft materials which do not damage the surface of the wafer, and nonwoven fabrics of fibers of these materials. Each of the above-mentioned materials is an insulating material having a low conductivity or almost no conductivity in itself. As one example, the resistivity value of closed-cellular polyurethane will be given below, together with resistivity values of other various materials. The resistivity of closed-cellular polyurethane is higher, as compared with the resistivity of the electrolytic solution for use in the present embodiment. In addition, the resistivity of closed-cellular polyurethane is higher, as compared with the resistivity of TaN which is one of the materials for forming an underlying barrier layer in forming a multi-layer wiring structure.
Metallic material (copper): 17 Ω·cm
Underlying barrier forming material: 200 Ω·cm
Electrolytic solution: 150 Ω·cm
Closed-cellular polyurethane (impregnated with electrolytic solution): 2 MΩ·cm

In addition, although the closed-cellular foamed material for forming the pad 111 can be slightly impregnated with the electrolytic solution, it does not show an electrolytic solution content on such a level that ions contained in the electrolytic solution will move positively to pass the electrolytic current so as to show a low conductivity. Therefore, in order to pass the current between the counter electrode 113 and the surface to be polished, it is important to provide the pad 111 with through-holes to thereby cause the electrolytic solution to make contact with the counter electrode 113. In view of this, as shown in FIG. 8(b), the pad 111 having a circular outer shape is provided with a plurality of through-holes 120 having an opening diameter of d, and the through-holes 120 are provided along the radial directions and the circumferential direction of the pad 111. Furthermore, in the radial directions of the pad 111, grooves 121a are formed so that the electrolytic solution can flow between the through-holes 120 arranged in the radial directions; in the circumferential direction, also, grooves 121b are formed so that the electrolytic solution can flow between the through-holes 120 arranged in the circumferential direction. As a result, the ions in the electrolytic solution can move between the surface of the pad 111 making contact with the counter electrode 113 and the surface of the pad 111 making contact with the wafer, through the through-holes 120. Therefore, electropolishing of the surface to be polished can be performed while mechanically polishing the surface to be polished with the pad 111. Furthermore, the electrolytic solution supplied via the flange through-hole 112 is uniformly supplied from the center toward the peripheral edge of the pad 111 along the radial directions and the peripheral direction of the pad 111 through the grooves 121a, 121b, and the constant flow of the electrolytic solution makes it possible to reduce the dispersion of composition of the electrolytic solution intermediately present between the counter electrode 113 and the surface to be polished. Further, the flow of the electrolytic solution makes it possible to discharge the gas and solid matter generated upon electropolishing, whereby the dispersion of current density distribution between the counter electrode 113 and the surface to be polished can be reduced over the entire area of the surface to be polished.

Here, in the case where the opening diameter d and the number of the through-holes 120 are small and in the case where the arrangement pattern of the through-holes 120 is uneven in the plane of the pad 111, the pad 111 as a whole has an increased resistivity, leading to an increase in voltage drop. Therefore, in order to achieve sufficient electropolishing, it is necessary to impress a high voltage between the counter electrode 113 and the surface to be polished. On the other hand, in the case where the total area of the through-holes 120 is excessively large, the area of mechanical sliding contact for the wiping to discharge the gas generated upon electropolishing and for the polishing is small, leading to an increase in the effective pressure exerted on the surface to be polished. Or, in the case where the through-holes 120 are arranged in a partial or localized pattern, there will be a dispersion of current density distribution.

Therefore, the opening diameter d of the through-holes, the number of the through-holes, and the arrangement pattern of the through-holes must be appropriately set based on the inter-electrode distance D and the resistivity R of the electrolytic solution used, so as to ensure that electropolishing can be performed at an appropriate voltage which is set for obtaining the required current density. For example, the opening diameter d of the through-holes and the number of the through-holes (total area of the through-holes), under the conditions of the following parameter values, are set in the following manner. Here, it is assumed that the wafer area is nearly equal to the whole area of the surface of the metallic film serving as the surface to be polished, and the inter-electrode distance D is equal to the thickness of the pad. In addition, the electrolytic solution is a solution containing the following components as principal components. Besides, the limit voltage for anode non-bubbling electrolysis means a voltage at which the metallic film constituting the surface to be polished can at least be removed through an electrolytic reaction by electropolishing.
Wafer area: Sw=300 [cm²]
Counter electrode area: Sc=300 [cm²]
Inter-electrode distance: D=10 [mm]
Resistivity of electrolytic solution: re=150 [Ω·cm]
Properties of electrolytic solution: Slurry containing 8 wt % of phosphoric acid +5 wt % of colloidal alumina+1 wt % of quinaldic acid
Limit voltage for anode non-bubbling electrolysis:
   V=2 [V]

In addition, under the conditions of these parameter values, the current flowing between the counter electrode and the wafer can be measured, for example, by the method shown in FIG. 9, and current density can be calculated. In FIG. 9, it is possible to measure the current flowing when a voltage of 2 V is impressed under the condition where a counter electrode 126 and a wafer 127 respectively making contact with both sides of a pad 125 are immersed in an electrolytic solution 128 in the state of being connected to a DC power source. Where the current density obtained is I=5 mA/cm², the inter-electrode resistance R which is the resistance between the counter electrode and the surface to be polished is calculated from Ohm's law V=I×R, as follows.

$$\begin{matrix}R [ Ω ] = V [ V ] \text{/} I [ mA ] \\ = 2 [ V ] \text{/} ( 5 [ mA \text{/} {cm}^{2} ] \times 300 [ {cm}^{2} ] ) \\ = 1.333 [ Ω ]\end{matrix}$$

Here, let the total area of the through-holes be S, from the relation R=re×D/S,

$$\begin{matrix}S = re [ Ω \cdot cm ] \times D [ cm ] \text{/} R [ Ω ] \\ = 150 \times 1 / 1.333 \\ = 112.5 [ {cm}^{2} ]\end{matrix}$$

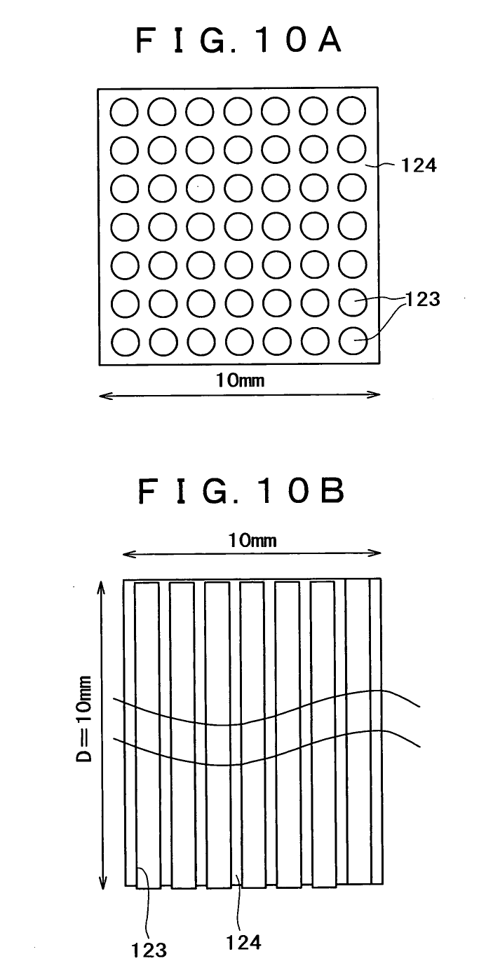

Thus, let the opening diameter d of the through-holes be d=1 mm, the area per through-hole is calculated to be about 0.00785 [cm²], and the number of the through-holes required over the entire body of the pad is 14322 pieces. Therefore, since the wafer area is 300 cm², the density of the through-holes is calculated to be about 47.7 pieces/cm². Accordingly, as one example of the arrangement pattern in which the pad is provided uniformly with the through-holes, the through-holes 123 are arranged as shown in FIGS. 10A and 10B. While the through-holes 123 are schematically arranged in columns and rows in FIG. 10A, required through-holes may be formed in the radial directions and the circumferential direction of the surface of the pad 124. Besides, as shown in FIG. 10B, the through-holes 123 are so formed as to penetrate from one side to the other side of the pad 124.

Therefore, in the case where a metallic film on the surface of a wafer is polished by use of the polishing apparatus described in this embodiment, application of an excessive processing pressure to the wafer due to mechanical polishing is obviated, and the metallic film can be efficiently planarized by a combination of electropolishing and mechanical polishing. Accordingly, even in the case of forming an insulation film from a brittle insulating material with a comparatively low mechanical strength, forming a metallic film so as to fill up trench portions for forming wirings in the insulation layer, and polishing the thus formed metallic film, it is possible to remove the surplus metallic film and thereby to form a planarized wiring layer, without materially lowering the polishing rate, as compared with the conventional technology, and without materially damaging the insulation film.

Next, an example in which a material capable of being comparatively amply impregnated with an electrolytic solution to show a high electrolytic solution content is used as the material constituting the pad will be described. The pad in this example is, for example, attached to a flange so as to function as a polishing tool. The flange used in this example is the same in structure as the flange described referring to FIGS. 8(a) and 8(b), i.e., the flange is provided in its center with a flange through-hole for supplying or sucking an electrolytic solution, and a counter electrode mounted between the pad and the flange is fixed to the wafer-side surface of the flange by electrode fixing screws. A conduction portion formed to extend along the circumferential direction of the flange through-hole makes contact with a connector connected to an external power source, and is connected to the counter electrode, thereby establishing electrical connection ranging from the connector to the counter electrode. The pad has a thickness of D, and is so attached as to cover nearly the whole surface of the counter electrode. As a result, the surface on one side of the pad makes contact with the counter electrode over nearly the whole area thereof, while the surface on the other side makes contact with the wafer, so that the inter-electrode distance between the counter electrode and the surface of the wafer is nearly equal to the thickness D of the pad.

In this example, for example, an open-cellular foamed material may be used as the material constituting the pad, whereby ions are permitted to permeate through the pad over the whole area of the pad, and a current can thus be passed between the counter electrode and the surface to be polished, without providing the pad with through-holes for contact of the electrolytic solution with the surface to be polished. In addition, the surface for contact with the counter electrode of the pad is provided with grooves for permitting the electrolytic solution to flow in the directions along the surface of the counter electrode, whereby it is possible to discharge the substances which would otherwise cause a dispersion of current density distribution, such as the products formed through electropolishing and the polishings generated upon mechanical polishing. Besides, the open-cellular foamed material to be impregnated with the electrolytic solution can be provided with a conductivity sufficient for the flow of an electrolytic current if the resistivity of the electrolytic solution is sufficiently low, and, when the pad is impregnated with the electrolytic solution sufficiently and uniformly, it is possible to pass the electrolytic current, without providing the pad with through-holes. For example, the resistivity value of polyvinyl acetal which is an open-cellular foamed material will be given as follows, in comparison with the resistivity values of other materials.
Metallic material (copper): 17 [Ω·cm]
Underlying barrier layer forming material (TaN):
   200 [Ω·cm]
Electrolytic solution: 150 [Ω·cm]
Open-cellular foamed polyvinyl acetal: 450 [Ω·cm](herinafter referred to as PVA; impregnated with the electrolytic solution in a content of 66 wt %)

Next, under the conditions of the following parameter values, the inter-electrode distance D between the counter electrode and the surface to be polished will be calculated.
Wafer area: Sw=300 [cm²]
Counter electrode area: Sc=300 [cm²]
Inter-electrode distance: D=10 [mm]
Resistivity of electrolytic solution: re=150 [Ω·cm]
Resistivity of impregnated PVA: rp=450 [Ω·cm]
Properties of electrolytic solution:
   Slurry containing 8 wt % of phosphoric acid+5 wt % of colloidal alumina+1 wt % of quinaldic acid
Limit voltage for anode non-bubbling electrolysis:
   V=2 [V]

Here, in the case where the current density required for electropolishing is 5 mA/cm², the inter-electrode resistance R is calculated from V=I×R, as follows:

$$\begin{matrix}R [ Ω ] = V [ V ] \text{/} I [ mA ] \\ = 2 [ V ] \text{/} ( 5 [ mA \text{/} {cm}^{2} ] \times 300 [ {cm}^{2} ] ) \\ = 2 / ( 0.005 \times 300 ) \\ = 1.333 [ Ω ] ,\end{matrix}$$

so that it is necessary for the inter-electrode resistance R to be not more than about 1.333. Therefore, from the wafer area Sw, the inter-electrode resistance R is calculated as follows:

$$\begin{matrix}R [ Ω ] = rp [ Ω \cdot cm ] \times D [ cm ] \text{/} Sw [ {cm}^{2} ] \\ = 450 \times 1 / 300 \\ = 1.5 [ Ω ]\end{matrix}$$

Thus, it is seen difficult to set the current density at 5 [mA/cm²] at an impressed voltage of 2 [V]. Accordingly, in order to set R to be not more than 1.333 [Ω], it is necessary to make the inter-electrode distance D smaller. Therefore,

$$\begin{matrix}D = 1.333 [ Ω ] \text{/} ( 450 [ Ω \cdot cm ] \times 300 [ {cm}^{2} ] ) \\ = 0.888 [ cm ] ,\end{matrix}$$

so that it is seen that in order to set the current density at 5 [mA/cm²], it suffices to set the inter-electrode distance D to be not more than about 8.88 [mm].

Therefore, even in the case of performing a combination of electropolishing and mechanical polishing by use of a pad not provided with through-holes, it is possible, by causing the electrolytic solution to flow in the directions along the surface of the counter electrode, to discharge the substances which would otherwise cause a dispersion of current density, such as the products formed through electropolishing and the polishings. In addition, by performing the mechanical polishing while performing sufficient electropolishing, the metallic film formed on the wafer surface can be planarized without lowering the polishing rate.

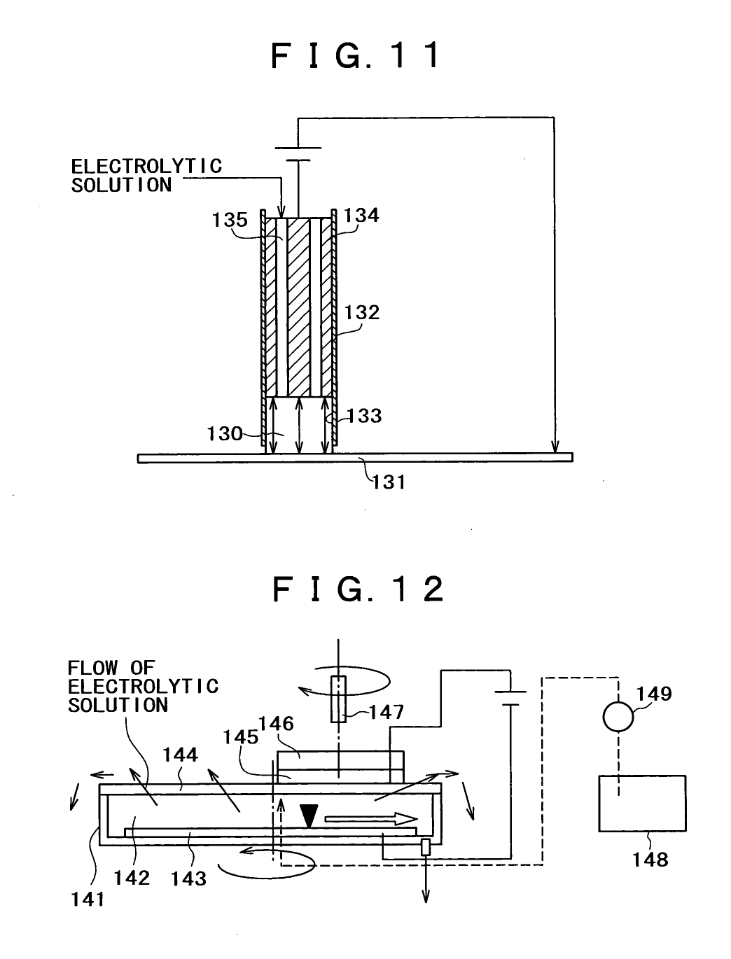

Furthermore, a further example of the present embodiment will be described referring to FIG. 11. The polishing apparatus in this example has a structure which has a pen-like outer shape with a pad 130 attached thereto and in which, by sliding the pad 130 on the surface to be polished of a wafer 131, a metallic film formed on the surface of the wafer 131 can be locally planarized. The pad 130 formed of PVA is attached to an opening portion 133 at one end of a tubular insulation tube 132 formed of an insulating material, and the pad 130 fronts on the surface to be polished of the wafer 131 from the opening portion 133 of the insulation tube 132. An electrode 134 is formed on the inside of the insulation tube 132 so as to make contact with the pad 130, and gas vent holes 135 are formed to extend along the insulation tube 132 from an end portion, on the side opposite to the side for fronting on the wafer 131, of the insulation tube 132. The gas vent holes 135 are so formed as to extend from the top face of the pad 130 and to reach the other end of the insulation tube 132. In addition, of the plurality of the gas vent holes 135 thus provided, at least one is an electrolytic solution supply hole for supplying the electrolytic solution therethrough, the electrolytic solution supplied through the electrolytic solution supply hole reaches the pad 130, and the electrolytic solution is supplied to the surface to be polished of the wafer 131 through the pad 130. Therefore, the electrolytic solution with little dispersion of composition is supplied to the surface to be polished with which the pad 130 makes contact; besides, with the electrolytic solution caused to flow, it is possible to discharge the substances which would otherwise cause a dispersion of current density distribution, such as the products formed through electropolishing and the polishings generated upon mechanical polishing.

Here, in the case where a material capable of being impregnated with the electrolytic solution is used as the material constituting the pad 130, the electrolytic solution with which the pad 130 is impregnated is supplied to the surface to be polished. On the other hand, where a material almost incapable of being impregnated with the electrolytic solution is used as the material constituting the pad 130, the pad 130 is provided with through-holes, and the electrolytic solution is supplied via the through-holes to the surface to be polished. In addition, the electrode 134 and the surface to be polished of the wafer 131 are connected to a power source disposed in the exterior so that the electrode 134 serves as cathode while the metallic film formed on the surface to be polished of the wafer 131 serves as anode.

In the polishing apparatus so shaped that the pad area brought into contact with the surface to be polished is smaller than the area of the wafer surface constituting the surface to be polished, a local portion of the metallic film formed on the wafer can be selectively electropolished and mechanically polished. Thus, this polishing apparatus is preferable for use in the case of polishing a specified region of the metallic film.

[Second Embodiment]

The polishing apparatus according to this embodiment is a face-down type polishing apparatus in which a wafer is mounted with its surface to be polished being directed downwards and is polished. First, the basic configuration of the polishing apparatus in this embodiment will be described referring to FIGS. 12 to 15. Incidentally, FIGS. 12 to 15 show the general configuration of a flange to which a pad, as a polishing tool, is attached. The face-down type polishing apparatus, with the active surface of a counter electrode being directed upwards, is little susceptible to influences of insulation between the surface to be polished and the counter electrode, an increase in resistance, dispersion of current density distribution, and the like which arise from the collection and stagnation of the gas formed through electropolishing. However, this type of polishing apparatus is susceptible to influences of the electrolytic products formed through electropolishing, a sludge, precipitates, coagulated abrasive grains, and other solid matters. Accordingly, a face-down type polishing apparatus which makes it possible to reduce these troubles will be described.

FIG. 12 is a sectional structural view showing the structure of a polishing apparatus in which a counter electrode 143 is entirely immersed in an electrolytic solution 142 contained in an electrolytic tank 141, and a wafer 145 is disposed on the upper face of a pad 144 which makes contact with the electrolytic solution 142. The wafer 145 is fixed to a wafer chuck 146 so that the surface to be polished where a metallic film is formed is directed to the lower side. When a wafer rotating shaft 147 connected to the wafer chuck 146 is rotated, the wafer chuck 146 is rotated about its center, whereby the wafer 145 is rotated about its center. The wafer 145 is rotated in the condition where the surface to be polished thereof provided with the metallic film is pressed against the pad 144, whereby the surface to be polished of the wafer 145 in contact with the pad 144 is mechanically polished. Further, the pad 144 is also rotated with its rotational axis as a center, and the rotation of the wafer 145 and the rotation of the pad 144 promise efficient mechanical polishing of the surface to be polished, simultaneously with electropolishing. Here, the wafer 145 and the counter electrode 143 are connected to an electrolytic power source so that the metallic film serves as anode and the counter electrode 143 serves as cathode.

Furthermore, an electrolytic solution 142 is fed out from an electrolytic solution tank 148, which is disposed in the exterior, through a pump 149, and the electrolytic solution 142 is supplied from the center of the counter electrode 143 into the electrolytic tank 141, whereby the electrolytic solution 142 is supplied through the pad 144 to the surface of the metallic film and is discharged in the manner of flowing from the center toward the peripheral edge of the metallic film. Therefore, the electrolytic solution with little dispersion of composition along the direction from the center toward the peripheral edge of the surface to be polished is constantly supplied, and the electrolytic solution 142 flows along the direction from the center toward the peripheral edge of the surface to be polished. This ensures that the gas and solid matter formed through electropolishing, the polishings and coagulated matter accumulated between the pad 144 and the metallic film at the surface to be polished, and the like are discharged through mechanical polishing from the surface to be polished into the electrolytic tank 141, so that the dispersion of current density distribution in the surface to be polished can be reduced. This effect is not limited to the case of supplying the electrolytic solution 142 from the center of the counter electrode 143; namely, the electrolytic solution 142 may be discharged via the center of the counter electrode 143, whereby the electrolytic solution can be caused to flow along the direction from the peripheral edge toward the center of the surface to be polished.

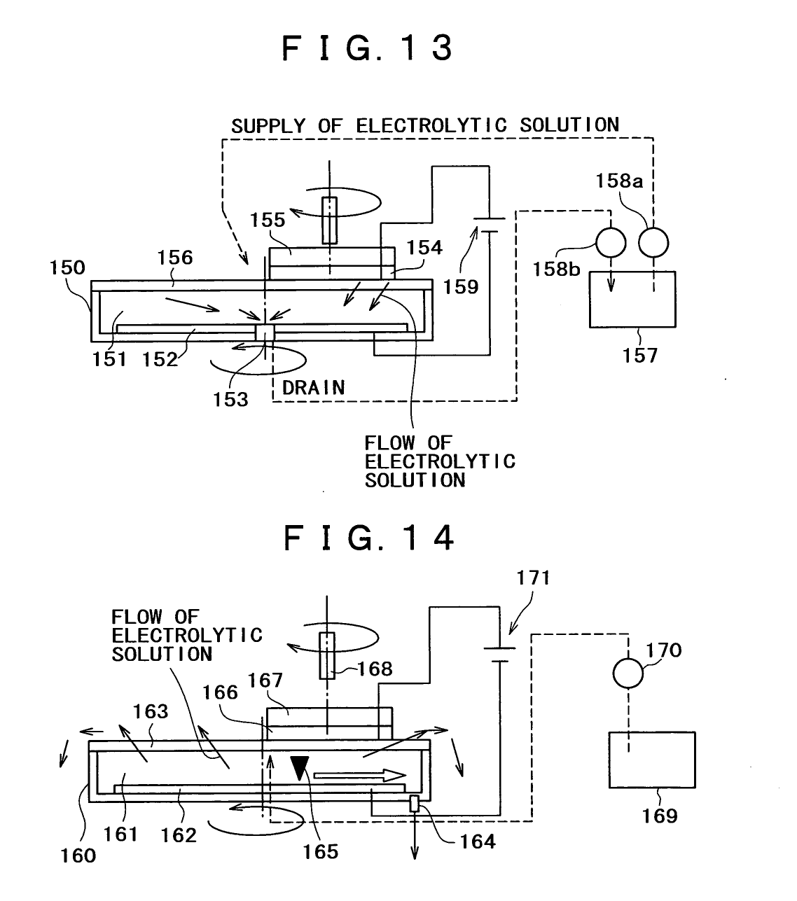

FIG. 13 is a sectional structural view showing a polishing apparatus in which mechanical polishing and electropolishing are performed in combination while circulating an electrolytic solution between an electrolytic tank and an electrolytic solution tank. In the polishing apparatus in this example, in the condition where a wafer 154 fixed to a wafer chuck 155 with its surface to be polished being directed downwards is rotated about its center, the surface of a metallic film serving as the surface to be polished is pressed against a pad 156, whereby polishing is performed. A counter electrode 152 disposed on the bottom surface of an electrolytic tank 150 is provided in its center with a drain 153 for draining the electrolytic solution 151 from the electrolytic tank 150, the electrolytic solution is sucked via the drain 153, and the electrolytic solution 151 is sent into an electrolytic solution tank 157 via a pump 158b; in addition, the electrolytic solution 151 is supplied from the electrolytic solution tank 157 to the upper surface of the pad 156 via a pump 158a. Here, the electrolytic solution 151 spread in the radial directions of the pad 156 due to the rotation of the pad 156 about its center spreads between the surface to be polished of the wafer 154 and the surface of the pad 156, and the metallic film on the surface of the wafer 154 and the counter electrode 152 are connected to an electrolytic power source 159, to serve as anode and cathode respectively, whereby electropolishing is performed. In addition, with the wafer 154 rotated about its center, the electrolytic solution 151 supplied through the pad 156 is caused to flow along the direction from the center toward the peripheral edge of the surface to be polished. As a result, the electrolytic solution 151 supplied to the surface to be polished shows a reduced dispersion of composition, so that there is little variation in the composition of the electrolytic solution 151 due to the electropolishing which is conducted continuedly.

FIG. 14 is a sectional structural view of a polishing apparatus in which the bubbles and solid matter adhering to the active surface of a counter electrode 162 as a result of electropolishing can be discharged by wiping them with a wiper 165. The polishing apparatus in this example includes a pad 163 so disposed as to make contact with an electrolytic solution 161 contained in an electrolytic tank 160, and a wafer 166 fixed to a wafer chuck 167 is pressed against a pad 163 while being rotated about a wafer rotating shaft 168, whereby the surface of a metallic film constituting the surface to be polished is planarized. On the bottom surface of the electrolytic tank 160, a counter electrode 162 is disposed oppositely to the wafer 166, and the metallic film on the surface of the wafer 166 and the counter electrode 162 are connected to an electrolytic power source 171, to serve as anode and cathode respectively, whereby electropolishing is performed. Here, a gas formed through electropolishing adheres to the active surface of the counter electrode 162, but bubbles containing the gas therein are discharged by wiping with the wiper 165, and the solid matter formed upon electropolishing, polishings and the like are also discharged. In addition, the electrolytic solution 161 supplied from an electrolytic solution tank 169 disposed in the exterior into the electrolytic tank 160 is caused, by the rotation of the pad 163, to flow in the direction from the center toward the peripheral edge of the pad 163, and is discharged. Therefore, not only the bubbles are discharged by the wiper 165 but also the electrolytic solution 161 flows along the direction from the center toward the peripheral edge of the surface to be polished, whereby foreign matter is discharged, and dispersion of composition of the electrolytic solution 161 is reduced. In addition, the electrolytic solution 161 can be discharged via a drain 164.

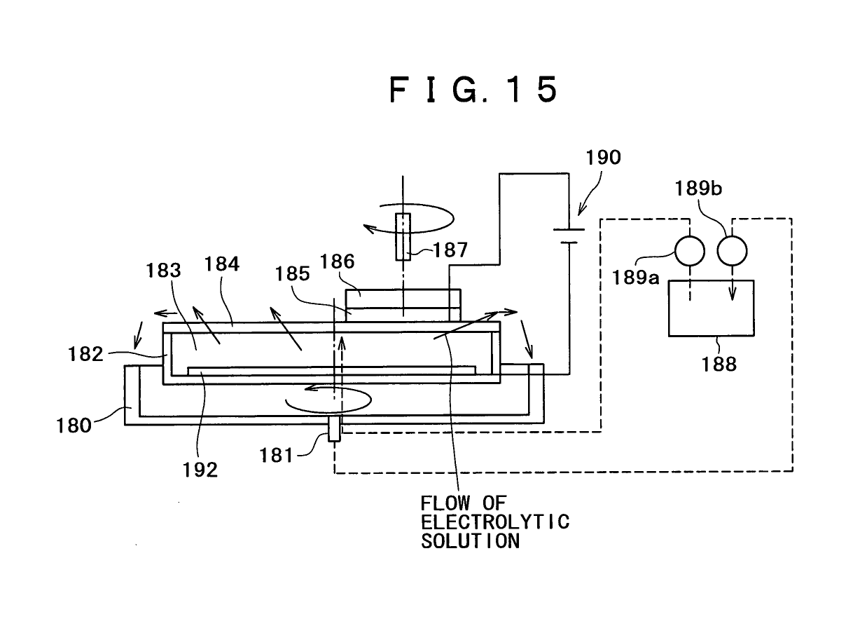

FIG. 15 is a sectional structural view of a polishing apparatus in which an electrolytic solution 183 is circulated between an electrolytic tank 182 and an electrolytic solution tank 188 provided separately from the electrolytic tank 182. A wafer 185 fixed to a wafer chuck 186 with the surface to be polished thereof directed downwards is polished by being pressed against a pad 184 which is rotated about its center. The pad 184 is in contact with the electrolytic solution 183 contained in the electrolytic tank 182, and the electrolytic solution 183 supplied from the center of a counter electrode 192 disposed on the bottom surface of the electrolytic tank 182 is supplied through the pad 184 to the surface to be polished, whereby mechanical polishing is performed, and the surface to be polished of the wafer 185 is planarized by electropolishing. Here, the electrolytic solution 183 discharged from the electrolytic tank 182 is recovered into a waste liquid recovery pan 180, and the electrolytic solution 183 is recovered through a drain 181, provided at the bottom surface of the waste liquid recovery pan 180, and a pump 189b into the electrolytic solution tank 188. In addition, the electrolytic solution 183 is supplied from the electrolytic solution tank 188 into the electrolytic tank 182 via a pump 189a. As a result, the electrolytic solution 183 is circulated between the electrolytic tank 182 and the electrolytic solution tank 188. Therefore, the electrolytic solution contained in the electrolytic tank 182 is constantly circulated with the electrolytic solution stored in the electrolytic solution tank 188, whereby the electrolytic solution with little dispersion of composition can be used for combined polishing composed of electropolishing and mechanical polishing, instead of a continued use of the electrolytic solution denatured due to electropolishing. Particularly, where the capacity of the electrolytic solution tank 188 is set larger than the capacity of the electrolytic tank 182, the electrolytic solution 183 can be circulated efficiently. For example, where the capacity of the electrolytic tank 182 is 5 L, it suffices to set the capacity of the electrolytic solution tank 188 to be about 20 L.

In the next place, a face-down type polishing apparatus according to this embodiment will be described below, showing an example thereof. Besides, examples of a polishing mechanism preferable for use in the face-down type polishing apparatus in this embodiment include rotary type ones, linear type ones and orbital type ones, of which the respective configurations will be described sequentially.

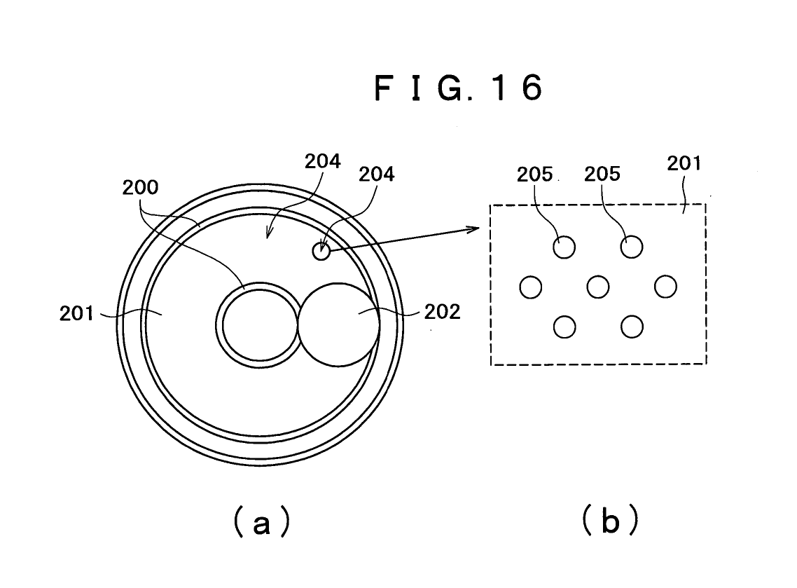

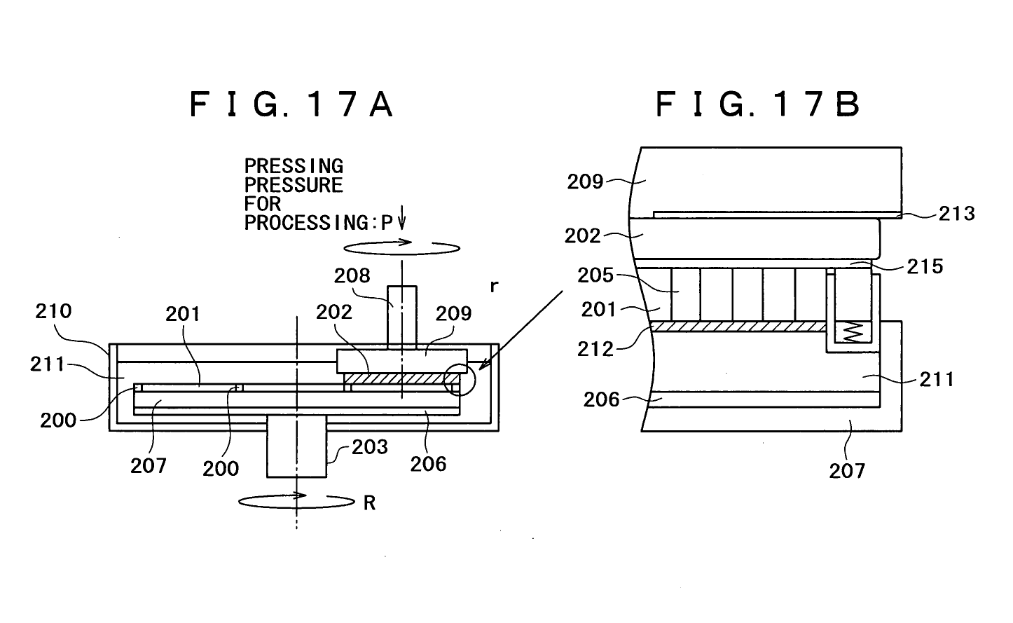

First, a rotary type polishing apparatus will be described referring to FIGS. 16(a) and 16(b) and FIGS. 17A and 17B. FIGS. 16(a) and 16(b) show plan structural views of the rotary type polishing apparatus. As shown in FIG. 16(a), a pad 201 is fixed between roughly circular wafer edge slide rings 200, and the wafer edge slide rings 200 prevent the pad 201 from being deviated in the radial direction. The width in the radial direction of the pad 201 is set to be comparable to the diameter of the wafer 202, so that the surface to be polished of the wafer 202 can be polished collectively. In addition, the pad 201 is rotated about a pad rotating shaft 203, and the wafer 202 is also rotated about its rotational axis, and the rotations of the pad 201 and the wafer 202 make it possible to efficiently polish the surface to be polished of the wafer 202.

Besides, the pad 201 is provided with slurry holes 204 communicating between the surface thereof for contact with a counter electrode 206 and the surface thereof for contact with the wafer 202. A slurry supplied from the surface plate side through the slurry holes 204 is also an electrolytic solution which is caused, by the rotation of the wafer 202, to flow in the radial directions from the center toward the peripheral edge of the wafer 202 and makes contact with the surface to be polished, and which flows in the condition where dispersion of composition thereof is reduced over the whole area of the surface to be polished. Therefore, there is little possibility that current density distribution might be dispersed in the surface to be polished due to dispersion of component distributions of the electrolytic solution. Accordingly, there is no possibility that an arbitrary region in the surface to be polished might be electropolished preferentially, and, thus, the surface to be polished is electropolished uniformly.

Besides, FIG. 16(b) is an enlarged view of the surface of the pad 201 shown in FIG. 16(a). The slurry holes 205 are arranged in rows in the vertical direction and the horizontal direction (in the figure) in the plane of the pad 201, and are arranged over the whole area of the pad 201. In this case, the diameter of the slurry holes 205 is so set that the total area of opening regions of the slurry holes 205 in the surface of the pad 201 is equal to a desired value.

FIGS. 17A and 17B are sectional structural views of the rotary type polishing apparatus. As shown in FIG. 17A, a pad rotating shaft 203 is connected to the center of a counter electrode 206, which is a cathode disposed opposite to a wafer 202, and a surface plate 207 is so disposed as to cover the entire part of the upper surface of the counter electrode 206. Further, a pad 201 is disposed on the surface plate 207, and rotation of the pad rotating shaft 203 rotates the pad 201, to thereby polish the surface to be polished of the wafer 202. Moreover, the pad 201 is fixed in the radial directions by wafer edge slide rings 200. Furthermore, the wafer edge slide rings 200 are connected to an anode of an external power source, and make contact with a metallic film formed on the surface to be polished of the wafer 202, whereby the metallic film is set as anode. Besides, the wafer 202 is fixed to a wafer chuck 209 connected to the wafer rotating shaft 208, and the wafer 202 is rotated about its center, with its surface to be polished being pressed against the pad 201, whereby the surface to be polished is polished and planarized. Thus, the cathode, the surface plate and the electrode pad are immersed in an electrolytic solution 211 contained in an electrolytic tank 210, the wafer 202 is also immersed in the electrolytic solution, and mechanical polishing with the pad 201 and electropolishing through an electrolytic action are performed.

Furthermore, FIG. 17B is an enlarged view obtained by enlarging the vicinity of an edge of the wafer 202. A cathode which is a counter electrode 206 is disposed on a surface plate 207, and a pad 201 is fixed on the upper side of the cathode, with a pad support net 212 therebetween. An electrolytic solution 211 is intermediately present between the pad support net 212 and the counter electrode 206. The pad support net 212 has such a structure as to support the pad 201 and to enable passage of the electrolytic solution 211 therethrough owing to the net-like shape thereof, and, therefore, the electrolytic solution 211 can be supplied to the pad 201 through the pad support net 212. The pad 201 is provided with slurry holes 205 communicating from the pad support net 212 to the pad surface for contact with a metallic film 215 formed on the wafer 202, so that the electrolytic solution 211 functioning also as a slurry is supplied to the surface to be polished, i.e., the surface of the wafer 202, through the slurry holes 205. In addition, the wafer 202 is fixed to a wafer chuck 209 through a wafer backing member 213, and makes contact with the wafer edge slide rings 200, whereby the wafer 202 is connected to an external power source, to serve as anode.

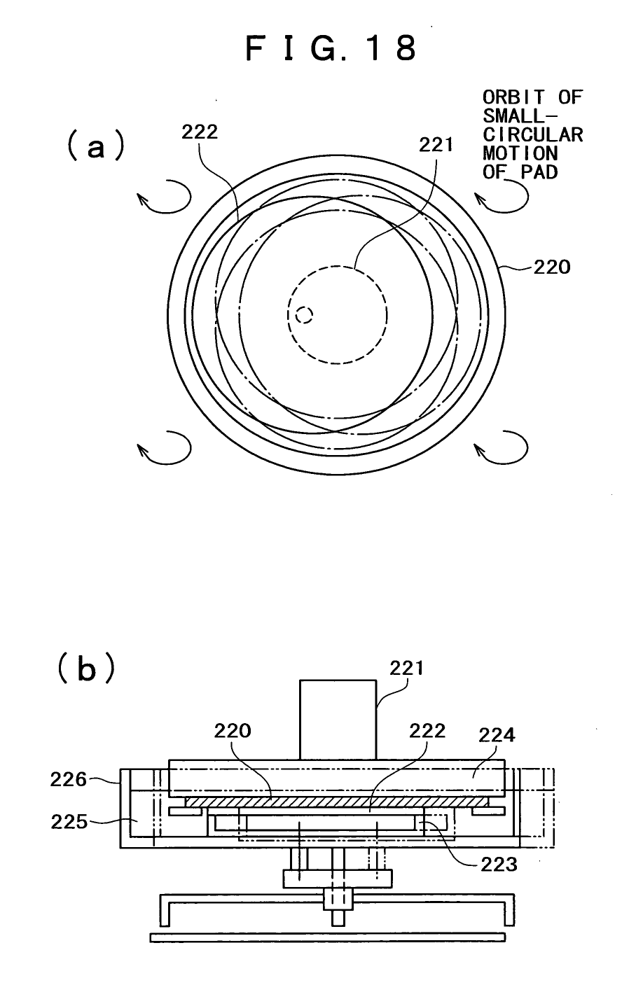

Next, the orbital type polishing apparatus will be described. FIG. 18(a) is a plan structural view of the orbital type polishing apparatus, and FIG. 18(b) is a sectional structural view. As shown in FIG. 18(a), a wafer 220 is polished in the condition where its surface to be polished is brought into contact with a pad 222 while the wafer 220 itself is rotated about a wafer rotating shaft 221. In this case, the wafer 220 is put into a small-circular motion while being rotated about its center, whereby the polishing is performed more efficiently.

Besides, as shown in FIG. 18(b), a pad 222 is disposed on the upper surface of a flange 223 connected to a rotary shaft, and the pad 222 polishes the surface to be polished of the wafer 220 while being rotated about its center. The wafer 220 is polished by being pressed against the pad 222 in the state of being fixed to a wafer chuck 224 to which a wafer rotating shaft 221 is connected. In this case, the pad 222 polishes the whole surface of the wafer 220 while performing a small-circular motion simultaneously with the rotation about its center. Therefore, an electrolytic solution 225 contained in an electrolytic tank 226 is caused to flow uniformly on the whole area of the surface to be polished of the wafer 220; as a result, dispersion of current density distribution between a counter electrode disposed on the pad 222 and the surface to be polished is reduced in the surface to be polished, and the electrolytic solution 225 is discharged in the manner of flowing from the center toward the peripheral edge of the surface to be polished. Here, the electrolytic solution 225 can be supplied or discharged through a nozzle disposed at the center of the counter electrode, so that the electrolytic solution can be caused to flow along the radial directions from the center toward the peripheral edge of the surface to be polished and along the circumferential direction of the surface to be polished. Particularly, where the wafer 220 and the pad 222 are rotated respectively about their centers and the pad 222 further performs a small-circular motion, the electrolytic solution 225 can be caused to flow efficiently in the area of the surface to be polished, and dispersion of current density distribution between the counter electrode and the surface to be polished can be reduced.

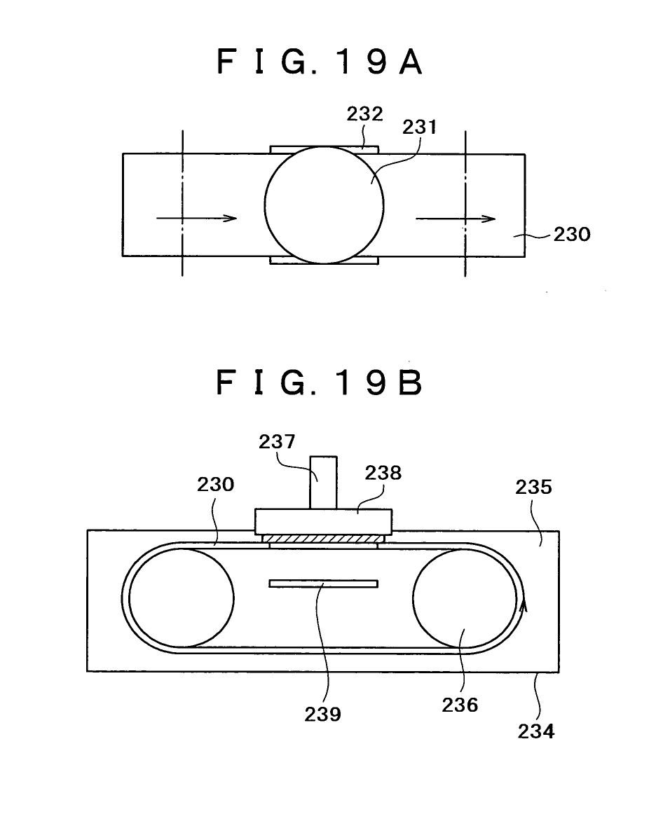

Next, the linear type polishing apparatus will be described. FIG. 19A is a plan structural view, in which a pad 230 is belt-like in shape, and is moved in the horizontal direction (in the figure) while polishing the surface to be polished of a wafer 231 which is rotated about its center. In addition, an electrode 232 makes contact with a metallic film formed on the surface to be polished of the wafer 231, to set the metallic film as anode. Besides, FIG. 19B is a sectional structural view, in which the pad 230 polishes the wafer 231 while being fed by rollers 236. The wafer 231 and the pad 230 are immersed in an electrolytic solution 235 contained in an electrolytic tank 234, the wafer 231 is rotated about its center in the state of being fixed to a wafer chuck 238 to which a wafer rotating shaft 237 is connected, and polishing is performed by the rotation of the wafer 231 and by the pad 230 fed by the rollers 236. Therefore, even though the pad 230 performs a parallel motion, the rotation of the wafer 231 about its center causes the electrolytic solution 235 to flow from the center toward the peripheral edge of the wafer 231, whereby it is possible to reduce the dispersion of current density distribution in the surface to be polished of the wafer 231 between a counter electrode 239, which is disposed in the electrolytic solution 235 at a position opposite to the wafer 231, and the surface to be polished. In addition, the wafer 231 and the counter electrode 239 are connected to an external power source, to serve as anode and cathode respectively, whereby electropolishing is performed together with the mechanical polishing.

As has been described above, by causing the electrolytic solution to flow along the directions from the center toward the peripheral edge of the surface to be polished, it is possible to discharge the products formed through electropolishing, and to suppress the possibility that the area between the counter electrode and the wafer might be insulated due to the presence of these products. In addition, it is also possible to reduce the dispersion of composition of the electrolytic solution between the counter electrode and the wafer. Therefore, the dispersion of current density distribution can be reduced over the whole area of the metallic film formed on the surface of the wafer, and, by the electrolytic combined polishing composed of a combination of mechanical polishing and electropolishing, a planar wiring layer can be formed without exerting an excessive pressure on the insulation layer constituting the wafer.

According to the polishing apparatus of the present invention, it is possible to cause the electrolytic solution to flow in the radial direction of the wafer, and to restrain a dispersion of the composition of the electrolytic solution intermediately present between the wafer and the counter electrode from being generated under the electrolytic action in electropolishing, and, by performing the polishing combined with mechanical polishing, it is possible to planarize the surface of the metallic film formed on the surface to be polished of the wafer. Furthermore, by the flow of the electrolytic solution, it is possible to discharge the foreign matters such as the gas and solid matter produced through electropolishing, the polishings generated upon mechanical polishing, coagulated matters formed by coagulation of components contained in the electrolytic solution, etc. Therefore, it is possible to restrain the area between the wafer and the counter electrode from being locally insulated by the foreign matters, and dispersion of current density distribution can be reduced over the entire area of the surface to be polished of the wafer. Accordingly, by the electrolytic combined polishing composed of a combination of the mechanical polishing performed without exerting an excessive pressure on the wafer and the electropolishing accompanied by a reduced dispersion of current density distribution, the surface of the metallic film serving as the surface to be polished can be planarized, with little damage to the insulation layer constituting the wafer. Therefore, also in producing a semiconductor device having a multi-layer wiring structure, the electrolytic combined polishing composed of a combination of electropolishing and mechanical polishing makes it possible to form fine wirings, while giving little damage to the brittle insulation layer.

Besides, according to the polishing method of the present invention, it is possible to reduce both the dispersion of composition of an electrolytic solution and the dispersion of current density distribution between a wafer serving as the object to be polished and a counter electrode. Therefore, where the electrolytic combined polishing composed of a combination of electropolishing and mechanical polishing is performed, a reduction in the damage to the underlying layer of the surface to be polished and planarization of the surface to be polished can be simultaneously achieved, with little lowering in the polishing rate.

1. A polishing apparatus for planarizing a surface to be polished by electrolytic combined polishing composed of a combination of electropolishing and mechanical polishing, said apparatus comprising:
voltage impressing means disposed oppositely to said surface to be polished; and
discharging means for discharging foreign matter intermediately present between said voltage impressing means and said surface to be polished.

2. A polishing apparatus as set forth in claim 1, wherein said discharging means discharges the foreign matter intermediately present between said voltage impressing means and said surface to be polished by causing an electrolytic solution to flow along the radial direction of said surface to be polished.

3. A polishing apparatus as set forth in claim 1, wherein said discharging means is provided at the center of said voltage impressing means.

4. A polishing apparatus as set forth in claim 2, wherein said electrolytic solution is caused to flow from the center toward the peripheral edge of said surface to be polished.

5. A polishing apparatus as set forth in claim 1, wherein said discharging means is electrolytic solution supplying means.

6. A polishing apparatus as set forth in claim 2, wherein said electrolytic solution is caused to flow from the peripheral edge toward the center of said surface to be polished.

7. A polishing apparatus as set forth in claim 1, wherein said discharging means is electrolytic solution discharging means.

8. A polishing apparatus as set forth in claim 1, wherein a polishing tool for polishing said surface to be polished comprises solution contact holes for bringing said electrolytic solution into contact with said surface to be polished.

9. A polishing apparatus as set forth in claim 8, wherein said solution contact holes are provided along the circumferential direction of said polishing tool

10. A polishing apparatus as set forth in claim 8, wherein said solution contact holes are provided along the radial directions of said polishing tool.

11. A polishing apparatus as set forth in claim 8, wherein said polishing tool comprises a groove for connection between said solution contact holes.

12. A polishing apparatus as set forth in claim 11, wherein said groove is formed in a surface, for making contact with said surface to be polished, of said polishing tool.

13. A polishing apparatus as set forth in claim 11, wherein said groove is formed along the circumferential direction of said polishing tool.

14. A polishing apparatus as set forth in claim 11, wherein said groove is formed along the radial direction of said polishing tool.

15. A polishing apparatus as set forth in claim 8, wherein the material constituting said polishing tool is a closed-cellular material.

16. A polishing apparatus as set forth in claim 8, wherein the material constituting said polishing tool is an open-cellular material.

17. A polishing apparatus as set forth in claim 1, wherein said voltage impressing means is an electrode.

18. A polishing apparatus as set forth in claim 1, wherein the polarity of said electrode is negative.

19. A polishing apparatus as set forth in claim 17, wherein said discharging means is a wiper for wiping the surface of said electrode.

20. A polishing apparatus as set forth in claim 1, wherein said surface to be polished is provided with a copper film.

21. A polishing apparatus as set forth in claim 1, wherein said voltage impressing means is disposed on the upper side of said surface to be polished.

22. A polishing apparatus as set forth in claim 1, wherein said voltage impressing means is disposed on the lower side of said surface to be polished.

23. A polishing apparatus as set forth in claim 1, wherein said foreign matter is an electrolysis product formed by said electropolishing.

24. A polishing apparatus as set forth in claim 23, wherein said electrolysis product is a gas.

25. A polishing apparatus as set forth in claim 23, wherein said electrolysis product is a solid.

26. A polishing apparatus as set forth in claim 1, comprising an electrolytic tank for reserving an electrolytic solution in which said surface to be polished and said voltage impressing means are immersed.

27. A polishing apparatus as set forth in claim 26, comprising electrolytic solution circulating means for circulating said electrolytic solution between itself and said electrolytic tank.

28. A polishing apparatus as set forth in claim 27, wherein said electrolytic solution circulating means comprises an electrolytic solution storage tank disposed separately from said electrolytic tank.

29. A polishing apparatus as set forth in claim 28, wherein the capacity of said electrolytic solution storage tank is greater than the capacity of said electrolytic tank.

30. A polishing method for planarizing a surface to be polished by electrolytic combined polishing composed of a combination of electropolishing and mechanical polishing, wherein
a counter electrode is disposed oppositely to said surface to be polished, and
foreign matter intermediately present between said counter electrode and said surface to be polished is discharged, whereby current density distribution is made nearly uniform between said counter electrode and said surface to be polished.
